(19) United States
(12) Patent Application Publication
(10) Pub. No.: US 2010/0296894 A1
(43) Pub. Date: Nov. 25, 2010

(54) SCREW FASTENING UNIT

(75) Inventors: Jeong-il KANG, Yongin-si (KR); Jun-seok AN, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 12/763,727

(22) Filed: Apr. 20, 2010

(30) Foreign Application Priority Data
May 25, 2009 (KR) 10-2009-0045367

(51) Int. Cl. F16B 37/04

(52) U.S. Cl. 411/172

(57) ABSTRACT

A screw fastening unit, which fastens a first member and a second member together, is provided. The screw fastening unit includes a screw member which includes a screw head from which a support portion extends in a fastening direction in which the screw member is fastened for supporting the first member, and a screw thread coupled to the screw head and which passes through a first penetrating hole formed through the first member; and a screw receiving member configured to receive the screw thread and which extends in a direction opposite to the fastening direction through a second penetrating hole formed through the second member and passes through the first penetrating hole.

### CROSS-REFERENCE TO RELATED APPLICATIONS

This application claims priority from Korean Patent Application No. 10-2009-0045367, filed on May 25, 2009, in the Korean Intellectual Property Office, the disclosure of which is incorporated herein by reference in its entirety.

### BACKGROUND

1. Field of the Invention

Apparatuses consistent with the present disclosure relate to a screw fastening unit capable of fixing different members while preventing a screw thread portion from protruding.

2. Description of the Related Art

Screws or bolts and nuts are generally required to assemble a plurality of different members.

When a screw is used to assemble the plurality of different members, a coupling hole is required as a screw receiving member capable of being screwed to a screw thread formed on the screw. In this situation, the coupling hole may have an internal thread formed on an inner circumference thereof. The internal thread may be formed to be complementary to the screw thread while the screw is fastened to the coupling hole.

Alternatively, when a bolt and nut are used to assemble the plurality of different members, each of the plurality of different members comprises a penetrating hole through which the bolt is able to pass, and the nut is coupled on a side opposite to a side where the bolt head is fastened. Accordingly, the plurality of different members coupled using the bolt and nut may continue to be in close contact with each other.

However, according to an increase in demand for slim electronic apparatuses with thin thickness, a layout occupied by component parts mounted in electronic apparatuses also needs to have a thickness as thin as possible. In particular, when component parts are coupled to a housing using screws or bolts in an electronic apparatus, screw thread portions of these screws or bolts protrude. However, such protrusion of screw thread portions may cause mechanical interference between the component parts, and make the electronic apparatus thicker.

In particular, in the case of an edge-type LED backlight unit on which people have recently focused, there is a need to reduce the thickness of component parts mounted in the LED backlight unit in order to make the LED backlight unit slimmer. Accordingly, the above-described problems need to be solved.

### SUMMARY OF THE INVENTION

Exemplary embodiments of the present invention may overcome the above disadvantages and other disadvantages not described above. Also, the present invention is not required to overcome the disadvantages described above, and an exemplary embodiment of the present invention may not overcome any of the problems described above.

The present invention provides a screw fastening unit which has an improved structure to prevent a screw thread portion from protruding in order to apply the screw fastening unit to a slim electronic apparatus.

According to an aspect of the present invention, there is provided a screw fastening unit, which fastens a first member and a second member, comprising a screw member which comprises a screw head from which a support portion for supporting the first member extends in a fastening direction in which the screw member is fastened, and a screw thread which passes through a first penetrating hole formed through the first member; and a screw receiving member which extends in a direction opposite to the fastening direction through a second penetrating hole formed through the second member and passes through the first penetrating hole.

The support portion may be provided in the form of a ring-shaped rib which is spaced apart by a predetermined distance from the screw thread.

According to a first exemplary embodiment of the present invention, the screw receiving member may be a stud member inserted into the second penetrating hole. In this situation, the stud member may be tightly fitted in the second penetrating hole.

According to a second exemplary embodiment of the present invention, the screw receiving member may be a burring portion which comprises an internal thread formed complementary to the screw thread in an inner circumference of the burring portion.

According to a third exemplary embodiment of the present invention, the screw receiving member may be an embossing portion.

The screw head may have one of a cross-shaped recess and a slot-shaped recess, in order to enable a user to use a driver.

Additionally the screw head may be formed in the form of one of a plurality of shapes, including a circle and a hexagon.

In the screw fastening unit according to the exemplary embodiments of the present invention, a height of the support portion, a height of the screw thread and a height of the screw receiving member may satisfy the following Equation (1):

H<S≦F≦H+t1+t2 Equation (1)

In Equation (1), H indicates the height of the support portion; S indicates the height of the screw thread; F indicates the height of the screw receiving member; and t1 and t2 indicate a thickness of the first member and a thickness of the second member, respectively.

As described above, according to the exemplary embodiments of the present invention, the screw thread does not protrude when different component parts are coupled to each other, and thus, it is possible to prevent interference between the screw thread and the different component parts, and it is easy to configure a slim electronic apparatus.

### BRIEF DESCRIPTION OF THE DRAWINGS

The above and/or other aspects of the present invention will be more apparent by describing certain exemplary embodiments of the present invention with reference to the accompanying drawings, in which:

FIGS. 1 to 4 are views illustrating various examples of a screw head of a screw member of a screw fastening unit according to exemplary embodiments of the present invention;

FIGS. 5A and 5B are sectional views illustrating a screw fastening unit according to a first exemplary embodiment of the present invention;

FIGS. 6A and 6B are sectional views illustrating a screw fastening unit according to a second exemplary embodiment of the present invention;

FIGS. 7A and 7B are sectional views illustrating a screw fastening unit according to a third exemplary embodiment of the present invention; and

FIG. 8 is a view illustrating part of a LED backlight unit of a liquid crystal display television (LED TV) to which a screw fastening unit is applied according to the exemplary embodiments of the present invention.

### DETAILED DESCRIPTION OF EXEMPLARY EMBODIMENTS

Hereinafter, exemplary embodiments of the present invention will now be described in greater detail with reference to the accompanying drawings.

In the following description, the same drawing reference numerals are used for the same elements even in different drawings. The matters defined in the description, such as detailed construction and elements, are provided to assist in a comprehensive understanding of the invention. Thus, it is apparent that the exemplary embodiments of the present invention can be carried out without those specifically defined matters. Also, well-known functions or constructions are not described in detail since they would obscure the invention with unnecessary detail.

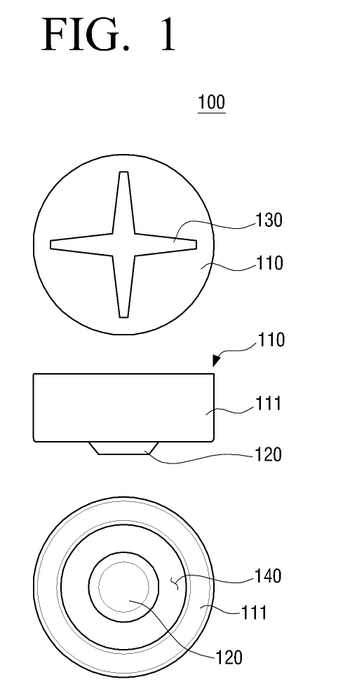

FIG. 1 illustrates a screw member 100 used in a screw fastening unit according to a first exemplary embodiment of the present invention.

The screw member 100 shown in FIG. 1 comprises a screw head 110 and a screw thread 120.

The screw head 110 has a support portion 111 formed integrally therewith. In more detail, the support portion 111 extends from the screw head 110 in a fastening direction in which the screw member 100 is fastened. The support portion 111 may have various forms, and may desirably be in the form of a ring-shaped rib which is spaced apart by a predetermined distance from the screw thread 120.

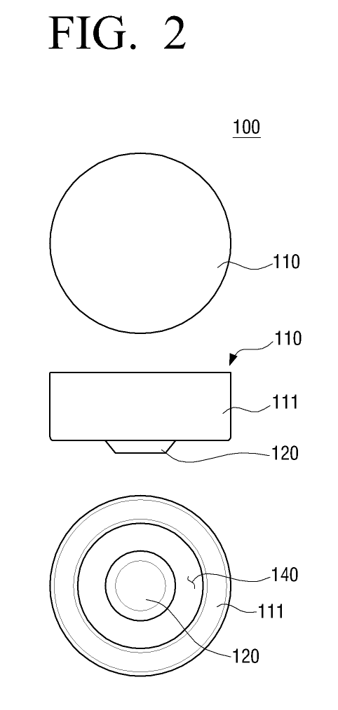

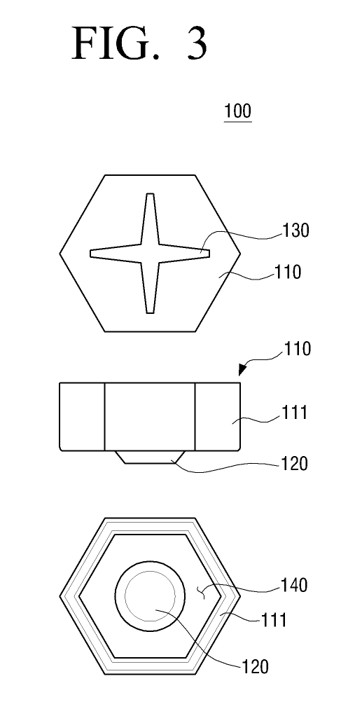

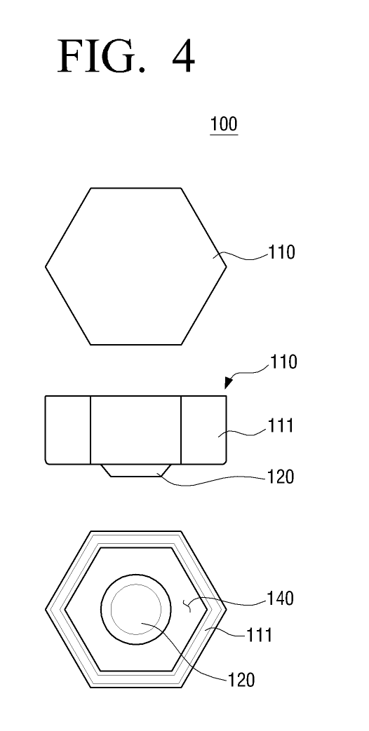

The screw head 110 may be provided in the form of a circle as shown in FIGS. 1 and 2, or in the form of a hexagon as shown in FIGS. 3 and 4. Additionally, the screw head 110 may be provided in the form of a polygon such as a quadrangle or an octagon, although not shown in the drawings.

As shown in FIGS. 1 and 3, a cross-shaped recess 130 may be formed on the top of the screw head 110 so that the screw member 100 may be tightened or released using a driver, but the cross-shaped recess 130 is not necessarily required. In other words, the support portion 111 of the screw head 110 protrudes in the fastening direction as described above, so even when there is no cross-shaped recess on the screw head 110 as shown in FIGS. 2 and 4, a user may tighten or release the screw member 100 by torquing his or her hand instead of a driver, or using a tool such as a wrench.

The screw thread 120 extends from the center of the screw head 110 in the fastening direction. Additionally, an accommodation groove 140 may desirably be formed in predetermined space between the screw thread 120 and the support portion 111.

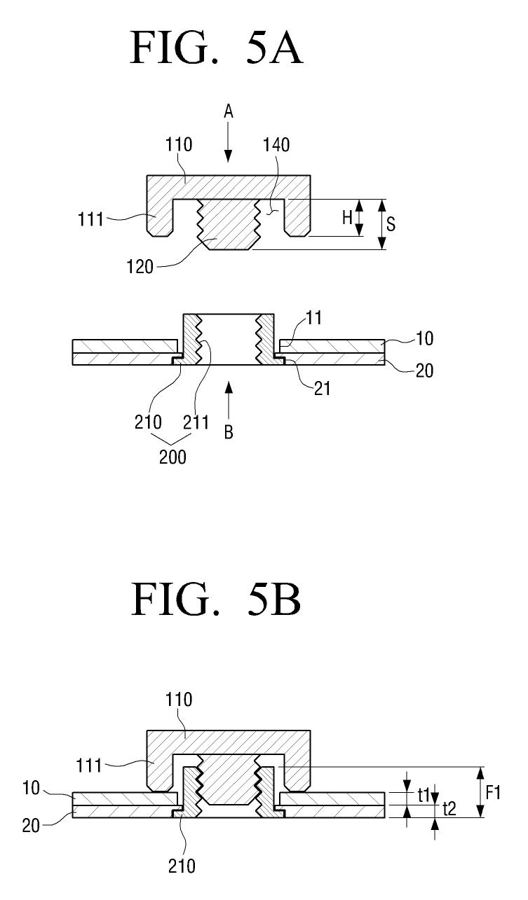

A height S of the screw thread 120 may desirably be longer than a height H of the support portion 111. Of course, even when the height S of the screw thread 120 is less than the height H of the support portion 111, the screw thread 120 may still be inserted into a screw receiving member 200 (see FIG. 5A), as will be described below. However, in this situation, it is difficult for the screw thread 120 to be completely inserted into the screw receiving member 200, and thus the screw member 100 may be unstably fastened in the screw receiving member 200.

Additionally, when the screw thread 120 is too long, it is impossible to prevent the screw thread 120 from protruding through the screw receiving member 200. That is, it is difficult to achieve the aspect of the present invention. Accordingly, the height S of the screw thread 120 may be regulated by a height F1 of the screw receiving member 200, a thickness t1 of a first member 10 and a thickness t2 of a second member 20 which are described below with reference to FIGS. 5A and 5B.

Referring to FIG. 5A, the screw receiving member 200 extends towards the first member 10 in a direction B opposite to the fastening direction A, through a second penetrating hole 21 formed through the second member 20.

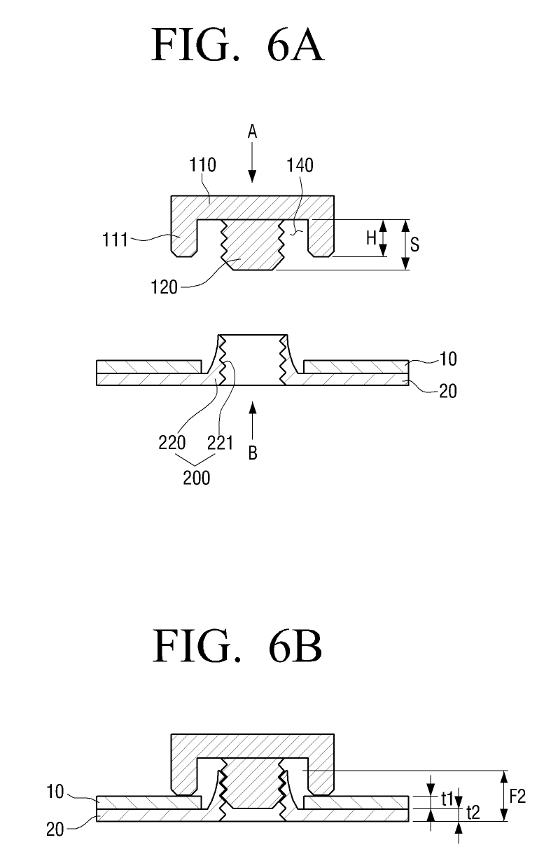

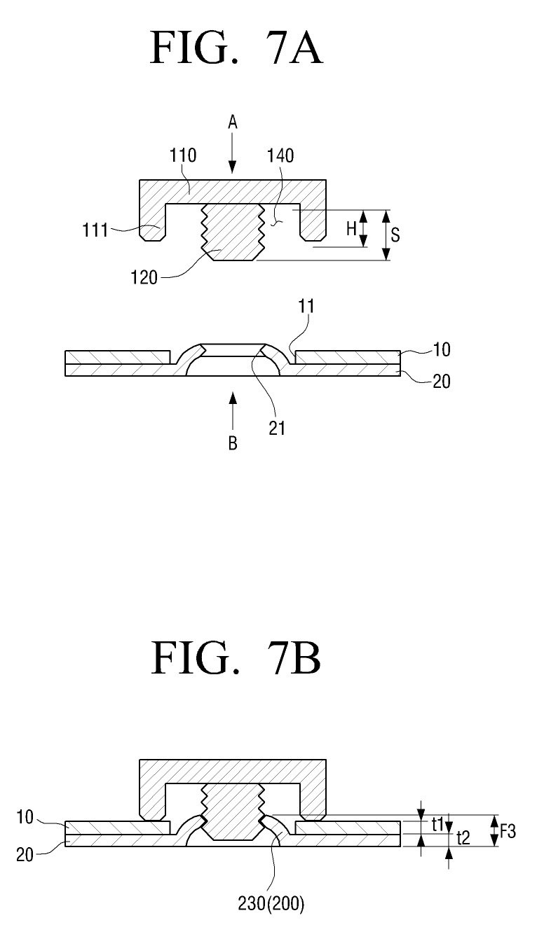

The screw receiving member 200 may be provided with a variety of shapes, for example, a stud member 210 as shown in FIGS. 5A and 5B, or a burring portion 220 as shown in FIGS. 6A and 6B, or an embossing portion 230 as shown in FIGS. 7A and 7B. As shown in FIGS. 5A to 7B, the screw receiving member 200 may desirably be formed to pass through a first penetrating hole 11 formed through the first member 10, when the first member 10 and second member 20 are being coupled.

FIGS. 5A and 5B are sectional views illustrating a screw fastening unit according to the first exemplary embodiment of the present invention.

The screw fastening unit shown in FIGS. 5A and 5B is used to screw the first member 10 to the second member 20. The first member 10 has the first penetrating hole 11, and the second member 20 has the second penetrating hole 21, as described above.

In order to screw the first member 10 to the second member 20, when the first member 10 is in close contact with the second member 20, the first penetrating hole 11 is aligned with the second penetrating hole 21. Accordingly, the screw member 100 is inserted into the stud member 210 through the first penetrating hole 11 in the fastening direction A, as shown in FIG. 5A.

The stud member 210 acting as the screw receiving member 200 to be screwed to the screw member 100 is tightly fitted in the second penetrating hole 21 in the direction B opposite to the fastening direction A. In this situation, an internal thread 211 is formed on an inner circumference of the stud member 210 to be screwed to the screw thread 120. It is also preferable that the stud member 210 does not protrude from the second member 20 in the fastening direction A, as shown in FIG. 5B.

Accordingly, if the screw member 100 is inserted into the stud member 210 in the fastening direction A, the screw thread 120 of the screw member 100 may be screwed to the internal thread portion 211 of the stud member 210 through the first penetrating hole 11. Thus, when the screw member 100 is screwed into the screw receiving member 200 to a fastening position, the support portion 111 forcibly makes contact with an upper surface of the first member 10 and the screw head 110 does not contact the first member 10.

In this situation, in order for the support portion 111 to pressurize (i.e., to forcibly make contact with) the first member 10 to fasten the first member 10 to the second member 20 without the screw thread 120 protruding, the height S of the screw thread 120 should be equal to or less than the height F1 of the stub member 210. If the height S of the screw thread 120 is longer than the height F1 of the stub member 210, it is difficult to prevent the screw thread 120 from protruding.

Additionally, if the stud member 210 becomes excessively long, the support portion 11 is not able to pressurize the first member 10, and thus the first member 10 and second member 20 may not be fastened tightly enough together. Therefore, there is a need to regulate the height F1 of the stud member 210. Desirably, the height F1 of the stud member 210 may be equal to or less than a sum of the height H of the support portion 111, the thickness t1 of the first member 10 and the thickness t2 of the second member 20.

The height of each component part in the screw fastening unit according to the first exemplary embodiment of the present invention may desirably satisfy the following Equation (1):

H<S≦F1≦H+t1+t2 Equation (1)

In Equation (1), H indicates the height of the support portion; S indicates the height of the screw thread; F1 indicates the height of the stub member; and t1 and t2 indicate the thickness of the first member and the thickness of the second member, respectively.

In this situation, an end portion of the stud member 210 is housed in the accommodation groove 140, as shown in FIG. 5B. Thus, there is no interference between the end portion of the stud member 210 and the screw head 110. Accordingly, it is possible for the support portion 111 to press the first member 10.

FIGS. 6A and 6B are sectional views illustrating a screw fastening unit according to a second exemplary embodiment of the present invention. The screw fastening unit of FIGS. 6A and 6B differs from the screw fastening unit of FIGS. 5A and 5B, in that the burring portion 220 is provided as the screw receiving member 200 and extends in the direction B opposite to the fastening direction A. Thus, the screw receiving member 200 and the second member 20 are integrally formed as a single member. The screw member 100 shown in FIGS. 6A and 6B is the same as that shown in FIGS. 5A and 5B. Additionally, an internal thread 221 is formed on an inner circumference of the burring portion 220 to be screwed to the screw thread 120.

Desirably, a height F2 of the burring portion 220 may also be regulated in the same manner as regulation of the height F1 of the stud member 210 for at least the reasons given above, and thus, the height of each component part in the screw fastening unit according to the second exemplary embodiment of the present invention may desirably satisfy the following Equation (2):

H<S≦F2≦H+t1+t2 Equation (2)

In this situation, an end portion of the burring portion 220 is housed in the accommodation groove 140, as shown in FIG. 6B. Thus, there is no interference between the end portion of the burring portion 220 and the screw head 110, and accordingly it is possible for the support portion 111 to press the first member 10.

FIGS. 7A and 7B are sectional views illustrating a screw fastening unit according to a third exemplary embodiment of the present invention. The screw fastening unit of FIGS. 7A and 7B differs from the screw fastening unit of FIGS. 5A and 5B and the screw fastening unit of FIGS. 6A and 6B in that the embossing portion 230 is provided as the screw receiving member 200 and extends in the direction B opposite to the fastening direction A. Thus, the screw receiving member 200 and the second member 20 are integrally formed as a single member. The screw member 100 shown in FIGS. 7A and 7B is the same as that shown in FIGS. 5A and 5B.

The embossing portion 230 extends in the direction B opposite to the fastening direction A so that the second penetrating hole 21 is able to pass through the first penetrating hole 11 when the first member 10 is being in close contact with the second member 20. In this situation, there is no separate process for screw-fastening with the screw thread 120.

Desirably, a height F3 of the embossing portion 230 may also be regulated in the same manner as regulation of the height F1 of the stud member 210 at least for the reasons given above, and thus the height of each component part in the screw fastening unit according to the third exemplary embodiment of the present invention may desirably satisfy the following Equation (3):

H<S≦F3≦H+t1+t2 Equation (3)

In this situation, an end portion of the embossing portion 230 is housed in the accommodation groove 140, as shown in FIG. 7B. Thus, there is no interference between the end portion of the embossing portion 230 and the screw head 110. Accordingly, it is possible for the support portion 111 to press the first member 10.

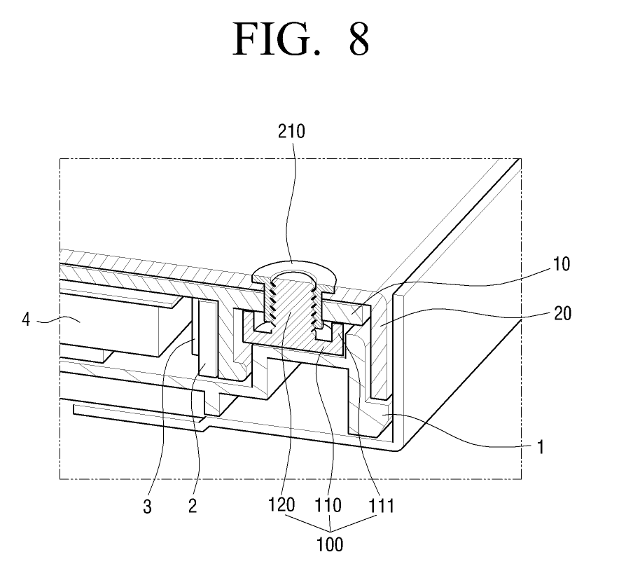

FIG. 8 exemplarily illustrates a situation in which the screw fastening unit according to the present invention is applied. In FIG. 8, a housing of a LED backlight unit in a liquid crystal display television (LED TV) is fastened using the screw fastening unit according to the first exemplary embodiment of the present invention. Reference number 1 represents a main frame, reference number 2 represents an LED panel, reference number 3 represents an LED light source, and reference number 4 represents light guide plate (LGP).

As shown in FIG. 8, when the first member 10 which is back chassis of the LED backlight unit and the second member 20 which is heat sink member of the LED backlight unit are coupled to each other, the screw member 100 does not protrude outside the second member 20. Accordingly, there is no concern about inference between the screw member 100 and other component parts of the LED backlight unit, even when the other component parts are mounted on the second member 20. Additionally, there is no need to worry about an increase in thickness of the LED backlight unit due to protrusion of the screw member 100 even when the other component parts are not mounted on the second member 20, and therefore, it is advantageous to realize slimness of an electronic apparatus.

The foregoing exemplary embodiments and advantages are merely exemplary and are not to be construed as limiting the present invention. The present teaching can be readily applied to other types of apparatuses. Also, the description of the exemplary embodiments of the present invention is intended to be illustrative, and not to limit the scope of the claims, and many alternatives, modifications, and variations will be apparent to those skilled in the art.

What is claimed is:

1. A screw fastening unit, which fastens a first member and a second member together, comprising:
a screw member which comprises a screw head from which a support portion extends in a fastening direction in which the screw member is fastened for supporting the first member, and a screw thread coupled to the screw head and which passes through a first penetrating hole formed through the first member; and
a screw receiving member configured to receive the screw thread and which extends in a direction opposite to the fastening direction through a second penetrating hole formed through the second member and passes through the first penetrating hole.

2. The screw fastening unit as claimed in claim 1, wherein the support portion is provided in the form of a ring-shaped rib which is spaced apart by a predetermined distance from the screw thread.

3. The screw fastening unit as claimed in claim 1, wherein the screw receiving member is a stud member inserted into the second penetrating hole.

4. The screw fastening unit as claimed in claim 3, wherein the stud member is tightly fitted in the second penetrating hole.

5. The screw fastening unit as claimed in claim 1, wherein the screw receiving member is a burring portion which comprises an internal thread formed complementary to the screw thread in an inner circumference of the burring portion.

6. The screw fastening unit as claimed in claim 1, wherein the screw receiving member is an embossing portion.

7. The screw fastening unit as claimed in claim 1, wherein a height of the support portion, a height of the screw thread and a height of the screw receiving member satisfy the following Equation:
H<S≦F≦H+t1+t2
wherein, H indicates the height of the support portion; S indicates the height of the screw thread; F indicates the height of the screw receiving member; and t1 and t2 indicate a thickness of the first member and a thickness of the second member, respectively.

8. The screw fastening unit as claimed in claim 2, wherein a height of the support portion, a height of the screw thread and a height of the screw receiving member satisfy the following Equation:
H<S≦F≦H+t1+t2
wherein, H indicates the height of the support portion; S indicates the height of the screw thread; F indicates the height of the screw receiving member; and t1 and t2 indicate a thickness of the first member and a thickness of the second member, respectively.

9. The screw fastening unit as claimed in claim 3, wherein a height of the support portion, a height of the screw thread and a height of the screw receiving member satisfy the following Equation:
H<S≦F≦H+t1+t2
wherein, H indicates the height of the support portion; S indicates the height of the screw thread; F indicates the height of the screw receiving member; and t1 and t2 indicate a thickness of the first member and a thickness of the second member, respectively.

10. The screw fastening unit as claimed in claim 4, wherein a height of the support portion, a height of the screw thread and a height of the screw receiving member satisfy the following Equation:
H<S≦F≦H+t1+t2
wherein, H indicates the height of the support portion; S indicates the height of the screw thread; F indicates the height of the screw receiving member; and t1 and t2 indicate a thickness of the first member and a thickness of the second member, respectively.

11. The screw fastening unit as claimed in claim 5, wherein a height of the support portion, a height of the screw thread and a height of the screw receiving member satisfy the following Equation:
H<S≦F≦H+t1+t2
wherein, H indicates the height of the support portion; S indicates the height of the screw thread; F indicates the height of the screw receiving member; and t1 and t2 indicate a thickness of the first member and a thickness of the second member, respectively.

12. The screw fastening unit as claimed in claim 6, wherein a height of the support portion, a height of the screw thread and a height of the screw receiving member satisfy the following Equation:
H<S≦F≦H+t1+t2
wherein, H indicates the height of the support portion; S indicates the height of the screw thread; F indicates the height of the screw receiving member; and t1 and t2 indicate a thickness of the first member and a thickness of the second member, respectively.

13. The screw fastening unit as claimed in claim 1, wherein, when the screw member is inserted into the screw receiving member to a fastening position, the support portion forcibly makes contact with an upper surface of the first member and the screw head does not contact the first member.

14. The screw fastening unit as claimed in claim 2, wherein an accommodation groove is formed between the support portion and the screw thread and is configured to receive the screw receiving member therein.

15. The screw fastening unit as claimed in claim 4, wherein an outer circumference of the stud member has a lip configured to couple with a lip formed on an inner circumference of the second member in the second penetrating hole.

16. The screw fastening unit as claimed in claim 5, wherein the screw receiving member and the second member are integrally formed as a single member.

17. The screw fastening unit as claimed in claim 6, wherein the screw receiving member and the second member are integrally formed as a single member.
